(19) United States
(12) Patent Application Publication
(10) Pub. No.: US 2014/0011180 A1
(43) Pub. Date: Jan. 9, 2014

(54) METHODS AND SYTEMS FOR IDENTIFYING AND SECURING EDUCATIONAL SERVICES

(71) Applicant: Yaphie, Inc., Edison, NJ (US)

(72) Inventors: Matthew Tomaziefski, Edison, NJ (US); Mohit Rajiv Shah, Edison, NJ (US)

(21) Appl. No.: 13/934,690

(22) Filed: Jul. 3, 2013

Related U.S. Application Data
(60) Provisional application No. 61/667,836, filed on Jul. 3, 2012.
(60) Provisional application No. 61/802,385, filed on Mar. 16, 2013.

(51) Int. Cl. G09B 5/00

(52) U.S. Cl. CPC G09B 5/00
USPC 434/362

(57) ABSTRACT

The present application describes methods and systems for assisting a student in the admission process for post-secondary education. The methods and systems include collecting user data from a student. In addition, admission data is collected from one or more post-secondary institutions. Next, a step for analyzing the user data in view of the admission data is provided. Further, recommendations based upon the analysis are sent to the student regarding academic planning, probability of gaining admittance into one or more post-secondary institutions, and suggestions for applying to one or more post-secondary institutions based upon the student's profile.

### CROSS-REFERENCE TO RELATED APPLICATIONS

This application claims priority to U.S. provisional application titled, “METHODS AND SYSTEMS FOR IDENTIFYING AND SECURING EDUCATIONAL SERVICES,” file. July 3, 2012, having a Ser. No. 61/667,836, and U.S. provisional application titled, “METHODS AND SYSTEMS FOR IDENTIFYING AND SECURING EDUCATIONAL SERVICES,” filed Mar. 15, 2013, having a Ser. No. 61/802,385. The disclosures of both U.S. provisional applications hereby are incorporated by reference in its entirety.

### BACKGROUND OF THE DISCLOSURE

1. Filed of Invention

This application generally relates to methods and systems providing vital educational resources to prospective students and parents to assist with understanding and preparing for enrolling in post-secondary education. This application also generally relates to methods and systems which provide any easy to use interface for gaining tutoring services for scholastic courses.

2. Related Art

The benefits of post-secondary education cannot be overstated. A four-year college degree provides students with opportunities commonly not offered to students without one. In fact, studies have shown that students who obtain a four-year college degree are estimated to make two to three times more money than their peers who forego higher education over the course of their lifetime. While most students aspire to attend college or universities directly after high school, many students and parents generally are overwhelmed and/or misguided with the overall planning and preparation phase necessary to gain admittance. For these reasons, approximately 1 in every 5 students defers enrollment in post-secondary education. The probability of a student attending college or university slowly declines every year upon deferment.

While enrolling and attending a post-secondary institution is considered a step in the right direction, only about a third of these students in-fact graduate. This is likely attributed to the lack of experience and insight students have before entering their first year. For instance, the curriculum may be too challenging in view of inadequate preparation at the high school level.

One of the main resources students and parents generally rely upon in the planning and preparation phase is their high school guidance counselor. Recent studies have shown that U.S. high school students receive about 38 minutes on average from a public school guidance counselor for college planning and preparation. In addition, while some school districts may be blessed with one or more excellent guidance counselors and mentors, most school districts in the United States unfortunately do not. This may be attributed to the socioeconomic demographic of the school district as well as the state's allocation of resources to educational programs. With fewer public resources allocated to properly prepare the majority of high school students for the road ahead, these students are at a significant disadvantage when competing for limited spots at selective colleges and universities.

What is desired in the art is a user-friendly method for assisting students and parents with planning, preparing and/or enrolling in post-secondary education offered, for example, at colleges and universities.

Also desired in the art is a user friendly system for assisting students with planning, preparing and/or enrolling in post-secondary education offered, for example, at colleges and universities.

Further desired in the art is a platform providing parents and students with web-based, real-time access via a user interface on a computer, to information related to planning and enrolling for post-secondary education.

Even further, it is desired to provide a user-friendly software program executable on a computer that may be accessed by students and parents in order to provide multiple educational services.

Yet even further, it is desired to provide a process and system that reduces the time spent planning and enrolling in post-secondary education.

Yet even further, it is desired to provide a process and system that increases awareness of post-secondary education requirements and expectations by offering a real-time social forum accessible by students and parents.

Yet even further, it is desired to provide students and parents with sufficient information about higher education opportunities and financial aid in any easy-to-navigate web-based platform to ensure informed, successful decisions are made.

Yet even further, it is desired to provide a web-based, tutoring scheduling platform, a question and answer platform, and/or a virtual tutoring session platform.

### SUMMARY OF THE INVENTION

According to a first aspect of the application, there is disclosed a method for assisting a student in the admission process for post-secondary education. The method includes the steps of collecting user data from the student and collecting admission data from one or more post-secondary institutions. The method also includes the step of collecting admission data from one or more post-secondary institutions. The method also includes the step of analyzing the user data in view of said admission data. The method further includes the step of delivering at least one of the following recommendations to the student: (i) required courses to complete prior to entering said one or more post-secondary institutions; (ii) probability of gaining admittance to said one or more post-secondary institutions; and (iii) suggestion for applying to said one or more post-secondary institutions according to said user data.

According to another aspect of the application, there is disclosed a system for assisting a student in the admission process for post-secondary education. The system includes a database and a web-based platform which operates on a networked computer. The database includes user data collected from the student, and admission data collected from one or more post-secondary institutions. The web-based platform is configured to analyze the user data in view of the admission data. The web-based platform includes at least one of the following student recommendation tools: (i) an academic tracker configured to identify remaining courses the student should complete prior to enrolling at the one or more post-secondary institutions; (ii) an academic predictor configured to provide the student with the probability of gaining admittance to the one or more post-secondary institutions; and (iii) an academic suggestor configured to provide the student with suggestions for applying to the one or more post-secondary institutions based upon the user data.

According to a third aspect of the application, there is disclosed a software platform application including computer readable instructions, executable by a processor of a networked computer.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 illustrates a user login and/or sign up page of the educational platform.

FIG. 2 illustrates a user dashboard listing exemplary categories of the educational platform.

FIG. 3 illustrates a category on the educational platform for college descriptions

FIG. 4 illustrates a chart explaining the relationship between products and databases on the educational platform.

FIG. 5 illustrates a user wish list on the educational platform listing schools, loans and scholarships.

FIG. 6 illustrates an input screen for an academic predictor product on the educational platform.

FIG. 7 illustrates an output screen for an academic predictor product on the educational platform which calculates a user's chance of admittance to desired colleges.

FIG. 8 illustrates an input screen for an academic suggestor product on the educational platform.

FIG. 9 illustrates an output screen for an academic suggestor product on the educational platform which assesses a user's match to colleges based upon a user's profile.

FIG. 10 illustrates an interactive product for meeting college faculty on the educational platform.

FIG. 11 illustrates a student connections product on the educational platform.

FIG. 12 illustrates a competitor analysis product on the educational platform.

FIG. 13 illustrates a scholarship search product on the educational platform.

FIG. 14 illustrates results from a scholarship search viewed on a display.

FIG. 15 illustrates a loan finder product on the educational platform.

FIG. 16 illustrates a tutoring scheduling product on the educational platform.

FIG. 17 illustrates a question and answer forum product on the educational platform

FIG. 18 illustrates an interactive tutoring platform product on the educational platform.

### DETAILED DESCRIPTION

As an initial matter, reference in this specification to “one aspect,” “an aspect,” “other aspects,” “one or more aspects” or the like means that a particular feature, structure, or characteristic described in connection with the aspect is included in at least one aspect of the disclosure. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but not other aspects.

This application generally is directed to methods and systems which provide students and parents with a platform to better educate and empower themselves on the overall task of applying to colleges. The processes and systems are linked with competitive and comparable landscape which allows students to engage with one another in a more comprehensive and dynamic manner. By so doing, students are in better position to appreciate their likely chance of admission to one or more post-secondary educational institutions. Moreover, students are capable of understanding the general criteria that may affect their chance of admission to one or more post-secondary educational institutions. Also, students may be able to register various characteristics and interests and obtain tailored recommendations for institutions based upon their input. By so doing, a student's chances of placement and retention at their desired post-secondary institution is increased. Additionally, the process and system helps students develop and implement an educational plan catered to one or more desired post-secondary institutions. This may include class enrollment, targeted grade goals, etc. which are designed to improve a student's likelihood in obtaining enrollment. As a whole, the above-mentioned technologies aide students in obtaining a more personal and individualized experience in their pursuit of post-secondary education.

Although colleges and universities are discussed as examples educational institutions to which the disclosed subject matter applies, the disclosed subject matter can be employed in connection with enrollment at other types of educational institutions, including, but not limited to, private secondary schools and community colleges.

In a first aspect of the application, there is disclosed a web-based platform providing one or more educational products and services for users. In an exemplary embodiment, the platform may be utilized via the Internet, such as, for example, a web browser application on a personal computer. The platform helps in many ways including but not limited to bridging the gap for educational resources and availability, educating and helping students and/or their families plan and prepare for their goals, and reduce overall redundancies and inefficiencies commonly encountered in the planning, preparing and application process for post-secondary institutions such as college and universities.

In an exemplary embodiment, the platform provides students with automated and user-friendly guidance counseling which far surpasses any counseling the average student receives in public schools. The platform is configured to provide sophisticated guidance counseling applications including but not limited to course planning, recommended sports and extra-curricular activities, comparisons with other students, scholarship opportunities, college profiles, social networking, tutoring capabilities, and college admission probabilities. Preferably, the platform is designed to collect student scholastic information, resume and aspirations, compare the information with a robust database of college information, and help students access their best options for applying to one or more post-secondary institutions. More preferably, the platform is configured to assist the student in achieving admission into the college of their choice.

In another exemplary embodiment, students who access the platform may have the ability to apply to nearly every University in the United States. In some embodiments, this may extend to include other educational institutions besides universities, and educational institutions in multiple countries.

Register/Login Module

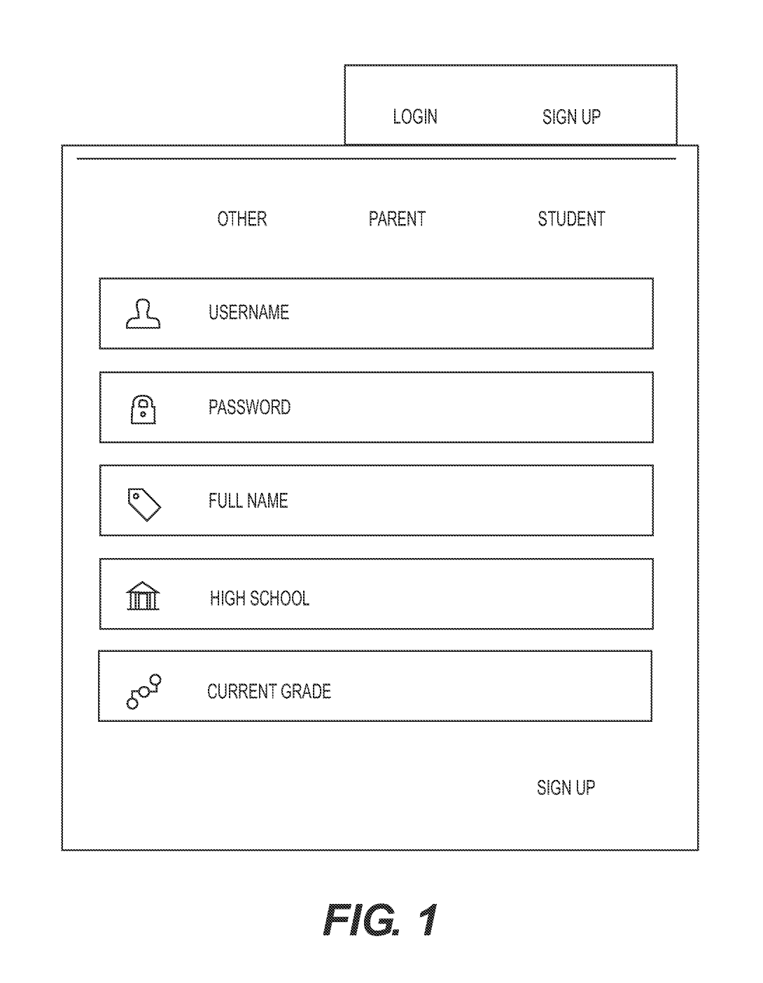

In another aspect of the application, the educational platform includes a registration and/or login module. Preferably, both registration and login prompts are provided on the same page as illustrated in FIG. 1. The Register/Login Module will be the setting at which new users can register. The module also may be the setting where registers user may log into the platform. In an exemplary embodiment, the login/register area will drop down. The primary reason for doing it this way is to allow the user to register or login without having to navigate away from the current page that they are viewing. As shown in FIG. 1, Registration requires a username, password, full name, high school and current grade/class year. Other user information may also be required, such as for example, security questions and credit card information, as necessary to obtain a profile by the administrator for the user. The user may also have to validate their email address before using any of the features requiring the user to be registered.

Until the user verifies his or her account, the log in page will prompt the user to do so at the time of login, or after attempting to use a feature that requires a user to be logged in. This prompt should also display the email address where the verification has been sent. Upon registration, the user gain access to the platform upon inputting their username and passwords. The username and password may be stored, e.g., “Remember Me” so that the user may automatically log in. In an exemplary embodiment, a password recovery option is provided should the user forget his password. In another exemplary embodiment, a username may be recovered upon correctly answering one or more security questions input during the initial sign up procedure.

User Dashboard

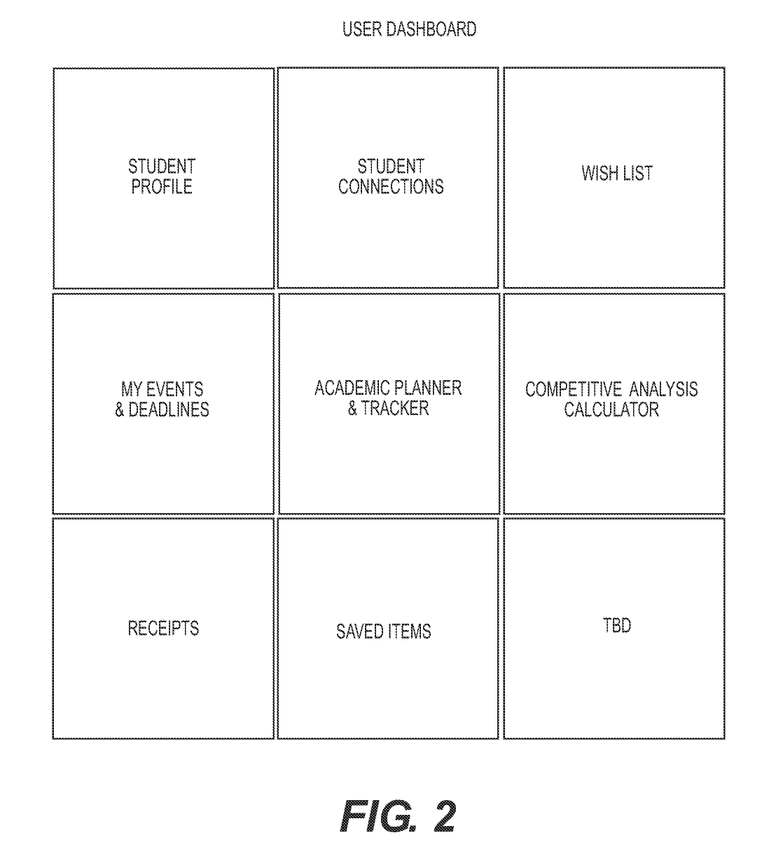

In another aspect of the application, upon logging into the platform, the user automatically will be directed to a dashboard. The dashboard will display to the user all of the notifications and updates regarding specific categories including but not limited to Events, Deadlines, News, Saved Items, and Receipts. In an exemplary embodiment as illustrated in FIG. 2, the dashboard includes at least the following: Student Profile; Student Connections; Wish List; My Events and Deadlines; Academic Planner and Tracker; Competitive Analysis Calculator; Receipts; and Saved Items.

In one embodiment, Events, Deadlines, and News will all be fed from schools, users, and/or scholarships that the user is currently following. Notifications may be displayed in full under each specific category. Hiding alerts allows the user to disable notification alerts for the specific category they are turning off. The notification alerts appear on the dashboard tab. In yet another embodiment, there is a following section.

In another exemplary embodiment, there is disclosed a ‘Following’ section which displays the schools, scholarships, and other users that the user is currently following. The user should have the ability to remove these schools/scholarships/users from their ‘Following’ from the dashboard on both, the normal view and view all.

In yet another exemplary embodiment, users will have the ability to customize and arrange the notification columns based upon user preference. For example, these may be up/down and/or left/right. The ‘View All’ button for each category will expand the column in the dashboard to display all of the notifications within that category.

Student Profile

From the dashboard, the user is able to input his or her information which is saved to the program. Users can choose to enter information directly into their profile. Alternatively, the user may opt to enter information using other products that will populate the user profile.

Generally, the first time the user views his or her own profile, he or she will be prompted to enter additional information. This information is optional and the user may choose not to add this information at the point of initially logging onto the system. The user can just begin to enter in the user input fields that would appear on their empty profile page. The user may alternatively choose between available data sets to fill out information needed for specific features and begin to populate their profile. These data sets include, but are not limited to, common application information, information for specific software product data, e.g., academic tracker, academic suggestor, and academic predictor, and common scholarship information. These data sets will be on a page of their own, separate from the student profile page.

The user has the ability to save and return to the student profile, or discard changes at any time. If a student chooses to ‘save and return’, the user can access this form again simply by opening the specific data set again, or this additional information the user enters will populate the student's user profile page. The user should see a profile completion percentage to view how much of their profile page is completed. It is recommended 100% of the user profile is completed in order to obtain the most benefit of the educational platform for assessing admittance to specific colleges and universities.

In an exemplary embodiment, when a user views his or her own student profile page, all of the data fields should be editable, from the profile page, by clicking the edit button to make the entire page of data fields editable. There should be one save button for all of the data, as opposed to having to save each field individually. There should also be a ‘discard changes’ button that returns the field to its previous state. When discarding the user should be prompted with a confirmation message similar to the following: ‘Are you sure you wish to discard the changes? Your changes will not be saved!

Users should be able to freely arrange the order in which the categories of information are displayed on their profile pages. In an exemplary embodiment, ‘Basic Information’ will be locked in at the top for all users. This allows the user to showcase what they believe to be their most impressive achievements/qualifications/information. Users arrange these categories with an up/down feature.

Users can choose to opt out of sharing their profile. If a user chooses to hide their profile, that user will be the only one able to view his or her own profile. When choosing to opt out the user should be prompted with a confirmation message similar to ‘are you sure you wish to hide your account’ with a brief description of why it would be disadvantageous for them to do so. Clicking ‘Follow’ adds the user to the user's ‘following list’ it also allows the user to receive notifications and alerts for this user in their user dashboard. Clicking ‘compare to’ sends the user to the student analysis tool with the user selected. ‘Following’ refers to ‘Wish List’. User can choose to ‘hide following info’. Doing so will hide the display that shows who that user is ‘following’ from other users.

College Profile

In another aspect of the application, an exemplary embodiment describes a user interface configured to provide a search feature to search for profiles of educational institutions. When using the search feature users will be prompted to enter a school name. In an exemplary embodiment, as the user enters the school name suggested, results will begin to appear below the search bar. For example, if a student enters Rutgers into the search bar, Rutgers University (New Brunswick), Rutgers University (Newark) and Rutgers University (Camden) should appear as suggested results. If the student clicks on one of the options from the suggested results list, the user will be sent directly to that school's profile page. However, if a user simply enters a school name into the search bar, they will be directed to the search results page.

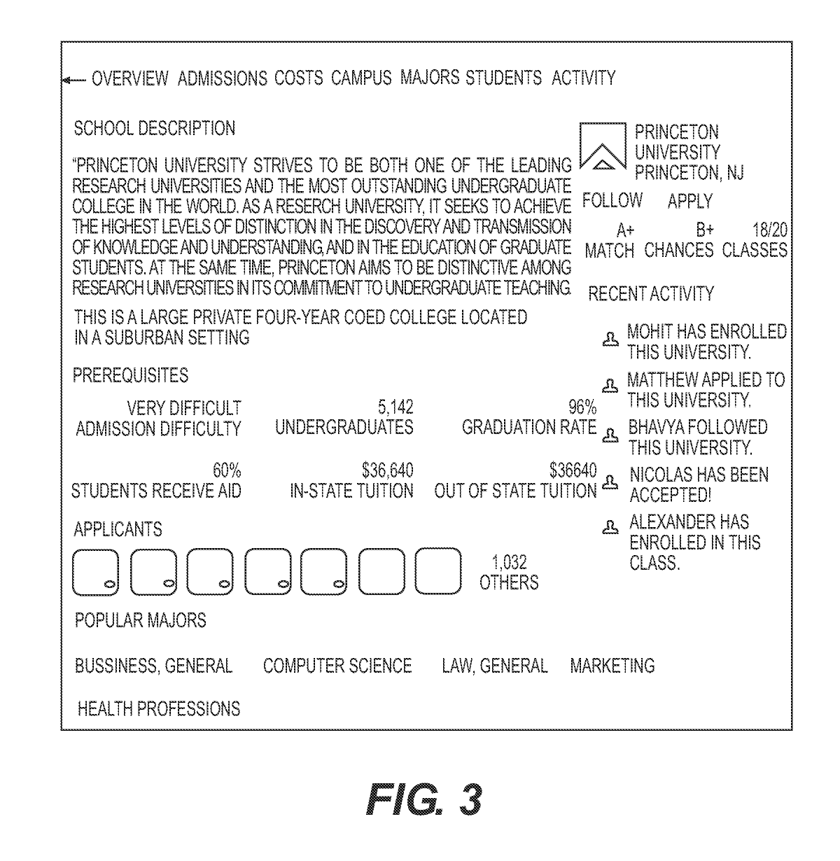

In a portion of the interface configured to display the search results, the resulting schools will, by default, sorted by relevance. Additionally users will be able to sort by any of the displayed information. As illustrated in FIG. 3, there is a screenshot of the main ‘Overview’ page displaying the school description, e.g., Princeton University. On this page, information regarding admission, undergraduate population, graduation rate, tuition, and financial aid information are displayed. The interface may be configured such that each school result will link to that school's profile page. In an exemplary embodiment, a social networking aspect may be connected to the page, such as, for example, Twitter and Facebook. Namely, a “Follow” interface element as illustrated in FIG. 3 may be provided whereby clicking it will add that school to the user's ‘following’ list. Additionally, the interface may be configured to include an interface element that will direct the user to the academic predictor aspect with the particular institution selected.

The search portion may also be configured to allow users to manipulate filters that will be displayed on the results page to further filter the displayed results. For most filters, aside from selecting a major, the user will be able to select multiple boxes as options. However, when selecting any option other than ‘No Preference’ this option should become unchecked. When using the ‘Select a Major’ filter the user will input a major or major category.

Other sections that may show up include but are not limited to Admissions, Costs, Campus, Majors, Students and Activity. On the search results page the resulting schools will, by default, sorted by relevance. Additionally users will be able to sort by any of the displayed information. In the screenshot, this information is ‘Average Cost’ and ‘Average Admission.’

Users can also manipulate filters that will be displayed on the results page to further filter the displayed results. For most filters, aside from selecting a major, the user will be able to select multiple boxes as options. However, when selecting any option other than ‘No preference’ the ‘No preference’ box should become unchecked. When using the ‘Select a Major’ filter the user will input a major or major category.

The college profile may also include match, chances and/or classes links as illustrated in FIG. 3. Clicking the chance icon will send the user to the academic predictor input page with the specific school selected. The user's inputted profile will be assessed to evaluate the likelihood of being accepted.

Clicking the ‘Classes’ icon will direct the user to the academic planner/tracker input page with the specific school selected. The user's classes and grades will be assessed to evaluate if the requirement for the specific post-secondary institution have been met.

Clicking on the ‘Match’ icon will direct the user to the academic suggestor page for assessing compatibility. The user's inputted profile will be assessed in view of the information provided for the selected post-secondary institution to evaluate if the match would be mutually beneficial for the user based upon his or her likes/dislikes, e.g., big/small school, Division 1 football/basketball, and national ranking of major.

Also illustrated in FIG. 3 is an ‘Apply’ icon. Selecting this icon redirects the user to an application for the selected institution. If the user has input all of his information into the Student Profile section, the application will auto populate all of the common user fields. By so doing, the user save hour not having to input data for each application. Such time may be spent writing the essay portions of the application. In another embodiment, the essay portions of the application may also auto populate based upon recognition software that detects common questions in college applications and subsequently scans the user's inputted information to assess if the information can be added.

In another exemplary embodiment, there may be an ‘Add to Cart’ section that will add this school to the users ‘Cart’ for applying to this school. This may be part of a “pay as you go” system, a monthly subscription system, and/or lifetime membership. Payments may be made on-demand, each month or a bulk payment for use of the software for number of years.

Database Management

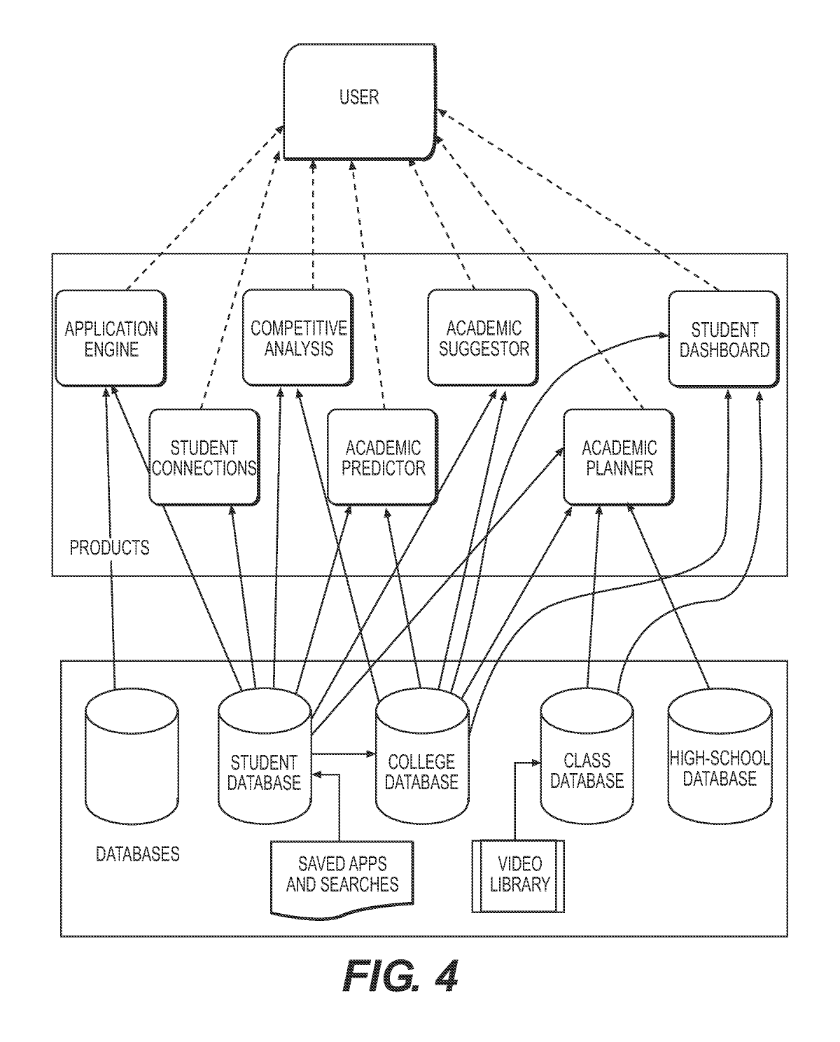

In another aspect of the application, the administrator manages the databases for the platform. In an exemplary embodiment as illustrated in FIG. 4, the database may include but is not limited to a student database including saved applications and searches; college database; class library including a video library; a high school database and combinations thereof. The databases are configured such that the information is transmitted to the selected user products including but not limited to the application engine; student connections; competitive analysis; academic predictor; academic suggestor; academic planner and student dashboard.

The administrator has access to add/edit information included in the database. The admin accesses the database via a user interface employed on an electronic device, such as a computer. In an exemplary embodiment, when the administrator adds a school to the database the administrator will be prompted to add a ‘school name’ and choose a data template from a drop down list, and enter the school's basic information (address, contacts, email, etc.) There will be a default selection on the drop down which will be the default data template. The admin can then choose between ‘quick add’ and ‘add & edit’. Quick add will add the school to the database and bring the admin back to Schools page. Add & Edit will add the school to the database and prompt the admin to edit the data for the school.

When editing a school, the admin can edit any of the information that is required from the data template. If a field is left blank, that field will not display on that school's college profile page.

The user interface may also be configured to include an administrative portion. A data templates section will display all of the data templates within the database. From this section the admin will be able to add data templates or edit the ones that currently exist. The admin should be able to see how many schools are currently using each data template.

When adding a data template the user will be prompted to create a template of data fields. Specifically the admin will add Categories, Sub categories, and either ‘Questions & Answer’ or ‘List’ entry fields. Any changes made when editing a data template will affect all of the schools currently using the template. After making changes to a template in use the admin should be prompted with a confirmation message. This confirmation message should include the number of schools currently using the template. For instance, if a subcategory is removed from the template in use by schools, that subcategory would be removed from each of those schools in the schools database. However, if a subcategory is added to the template in use, the admin should be prompted with a list displaying the schools currently using that template, and when editing that schools data the admin should be prompted to enter the new information.

In a display area of the administrative section, the admin will be able to set the display setting for data templates for the college profile page. The admin will be able to add displayed information by adding the field name designated to the desired field from the Data Template. This will require uniformity of field names through data templates. When adding a ‘Display Information’ the admin will be prompted to enter a field name and to designate a display name, which will be in the title section of the search results, e.g., Average Cost, Average Admission, etc.

In a schools portion of the user interface, the schools section will display all of the schools within the school database. From here the admin will be able to add schools to the database and edit any of the existing schools. The admin should be able to search for schools by name, unique id, or by the data template it uses.

The schools section will display all of the schools within the school database. From here the admin will be able to add schools to the database and edit any of the existing schools. The admin should be able to search for schools by name, unique id, or by the data template it uses.

Product Summary

In another aspect of the application, a general product list may be provided on the platform. Each product may have a product summary page before reaching the product itself. Preferably, the product summary page will describe the product in great detail via video and text. The video should summarize the product in detail. Preferably, the video will include a description and/or tutorial. More preferably, the video should be embedded on the page employing API protocol from a provider, such as for example YouTube, Vimeo, etc.

A link on the product summary page will lead to the product input page. Users have an option to skip the summary page. Preferably, the skip option is provided after the user has at least viewed the product description and/or tutorial at least one.

In another embodiment, a ‘Products’ portion is provided on the products summary page via the user interface. The products portion may be configured so as to display a brief summary of all of the aspects that directly relate to college planning. This portion of the interface may be configured to provide hyperlinks or other interface elements directing the user to all of the aspects' summary pages. For example, clicking on the illustrated ‘Academic Tracker’ would direct the user to that aspect's summary page.

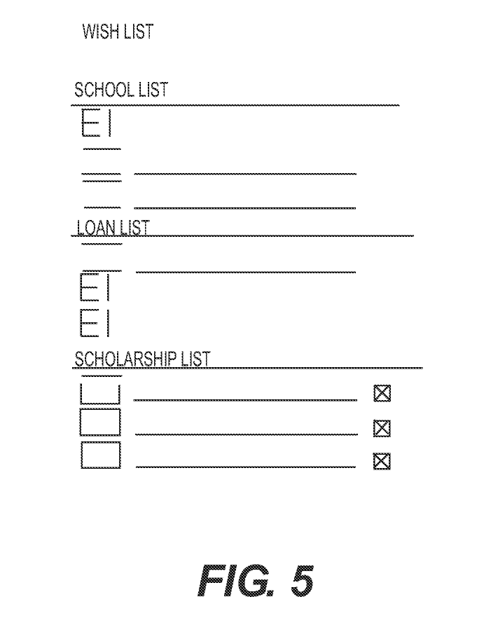

In yet another embodiment, a product wish list is provided. An exemplary embodiment is illustrated in FIG. 5. This list may be accessed from the product summary page. Alternatively, the product wish list may be provided directly from the user dashboard described above. The product wish list may include but is not limited to a school list, loan list and scholarship list.

Frequently Asked Questions

In another aspect of the application, the platform may include a frequently asked questions page, e.g., ‘FAQ’. The link may generally be found on the homepage. This page will feature frequently asked questions, answers, and a contact form for users who cannot find the resolution to their current problem offered on this page. One of the purposes of this page is to provide user support for products found on the product summary page.

In an exemplary embodiment, a user interface is provided for a college planning frequently asked questions aspect, and its relationship to other aspects of the system. This aspect is configured to provide area in which users can go for support for our products. This page will feature frequently asked questions, answers, and a contact form for users who cannot find the resolution to their current problem offered on this page. Preferably, the FAQ page will include an inline search bar to search through the posted frequently asked questions. Results should appear in order of relevance.

The posted questions may be configured to appear in the form of a table of content on the FAQ page. Both, the questions and categories that appear in the table of content will be anchored to the question and category as they appear in content below the table of content. The questions may be separated into relevant categories. For example, the categories may include but are not limited to the following categories: College Planning Process, College Application Process, Academic Tracker, Academic Suggestor, Academic Predictor and combinations thereof. Each question is assigned to a category. Next to each anchored area may be a return to top’ link. For users who are unable to resolve their issue through the already posted frequently asked questions, directions for contacting someone for assistance may be provided via a form on the FAQ page. Since the user will already be logged into the system, the users may only need to provide the question.

Products/Services Provided on Platform

In yet another aspect of the application, there is described one or more products/services provided on the platform. For example, the platform includes but is not limited to an academic planner/tracker, academic suggestor, academic predictor, meeting the dean, student communication, student comparison, high school profile, class profile, college planning, financial planning, and scholarship planning.

Academic Planner/Tracker

In one aspect of the application, users will use the Academic Planner to help plan for applying to specific schools of interest. The Academic Planner will show the user the required classes for admission into the selected school compared with the classes that the user has already taken. Additionally it will provide the student with a plan for taking the remaining classes over the users remaining years of high school.

Users will be required to input via a user interface the number of year of each subject that they have taken thus far at their high school. Additionally, users will have to identify these classes they have taken as college prep, honors, or AP.

Users will be required to input a school or select a school from the list of school that they are currently ‘Following.’ The user will see his/her composite class chart compared with the state requirements for his/her state, and the recommended composite class chart for the school the user has selected. On this chart the user should see both the breakdown of the classes (CP/HR/AP) and the total years.

In this section the specific class requirements for each category will be displayed. For instance this section will display ‘AP CalculusAB'or ‘AP Calculus BC’ as opposed to just a year required of AP Math. Also in this section the user can input the specific classes that he/she has taken at his/her specific high school. These classes that the user can input will be pulled from the ‘courses’ section of their high school's ‘high school profile.’ If, however, there are no courses entered in the ‘courses’ section of the high school profile the user should be able to select classes from the classes that the school requires.

After the user has entered his/her class specifications, he/she should be able to generate a schedule laying out the classes that the user still has to take over his/her remaining years at high school. The user can choose to email, print, or save this schedule. Saving this list sends it to the users saved items section of the dashboard. Following all ‘follows’ every ‘Class’ in the schedule.

Academic Predictor

In another aspect of the application, users may also have the option to use the academic predictor service provided on the platform. Users will use the Academic predictor to determine their probability of admission into a selected school. The resulting probability should be displayed to the user as a percentage.

Users will be required to enter personal and scholastic information. This information will help determine the user's probability of admission by checking it against schools criteria for an ideal applicant, trending admission data, as well as historic admission information. The personal information will flow from student profile if they have the profile data there. They will have the ability to change the input. If they update the input then the confirmation message will come to update the profile fields. The input section may have the weighting associated with the parameters where student can specify which criteria are important for them. This will be used in the algorithm to get the results.

Users will be required to enter a school name or choose a school from the list of schools that they follow. For entering a school name the user will see the same autofill feature that is used while ‘searching’, however the user will be forced to select a school from the drop down here unless it is spelled identically to how it is indexed. The results will be displayed, by default, descending from the highest percentage. Clicking follow will add that school to the user's ‘Following’ List. Add to cart will add this school to the users ‘cart’. Clicking on the logo or school name should take the user to the school's profile page.

Table 1 as provided below illustrates the calculations according to the code of the software program. The calculations are performed to arrive at the student's assessment whether the admittance would be expected. In an exemplary embodiment, the software may have about a 10% stand deviation. Preferably, the stand deviation is about 5% stand deviation.

TABLE 1

| | Variable being | |
|---|---|---|
| | used in | Value example |
| | calculation | (all numeric |
| Scholastic (academic) Information | below | values) |
| SAT-Math (25 percentile score) | SATM25 | 610 |
| SAT-Reading (25 percentile score) | SATR25 | 600 |
| SAT-Writing (25 percentile score) | SATW25 | 620 |
| SAT-Math (75 percentile score) | SATM75 | 700 |
| SAT-Reading (75 percentile score) | SATR75 | 690 |
| SAT-Writing (75 percentile score) | SATW75 | 700 |
| GPA (mean of the students gpa join this | GPA_Mean | 3.5 |
| school) | | |
| Rank in Class (mean of the students join | Rank_Mean | 0.9 |
| the school) | | |
| Deviation for GPA (based on the | GPA_dev | 0.3 |
| difficulty to enter the school) | | |
| Deviation for Rank (based on the | Rank_Dev | 0.3 |
| difficulty to enter the school) | | |

Following weight (priority) information is provided in Table 2 below. The information entered by admin based upon their understanding the priority with which colleges gives priority to different subjects and other extra curriculars. This will also be entered in college profile database in the CMS.

TABLE 2

| Weight(priority) for | Variables being used in | Value example |
|---|---|---|
| scholastic data | calculation below | (numeric data) |
| Weight for SAT Math | WSATM | 5 |
| Weight for SAT Reading | WSATR | 5 |
| Weight for SAT Writing | WSATW | 3 |
| Weight for GPA | WGPA | 4 |
| Weight for Rank | WRANK | 3 |
| Weight for school | WSCHOOL | 3.5 |
| (difficulty factor) | | |
| | Variable being used in | |
| Weight (priority) for Extras | calculation below | Value example |
| Weight for Curriculum | WCURRICULAM | 2 |
| Weight for Honors | WHONORS | 3 |
| Weight for essays | WESSAYS | 3 |

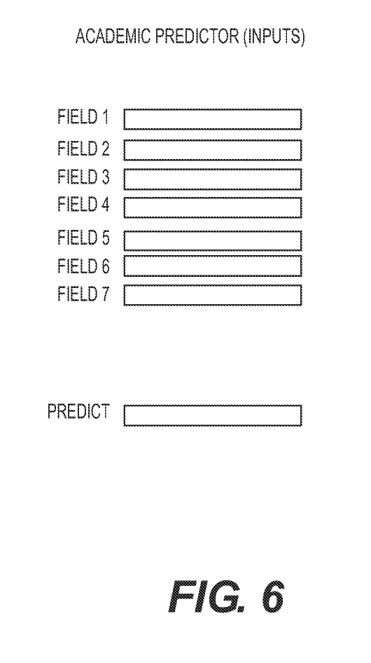

The student enters the required inputs on a page displayed on the user interface as illustrated in FIG. 6. While FIG. 6 lists only 7 fields to be completed by the user, any number of fields may be designated in accordance with the algorithm being supplied to predict admittance into a post-secondary institution. Following values (inputs) will be entered by the students when they will select the academic predictor tool. The values are input, for example, as shown in Table 3 below.

TABLE 3

| | Variable being used in calculation | Value |
|---|---|---|
| | below | example |
| Scholastic | | |
| inputs | | |
| SAT Math | SATM INPUT | 740 |
| SAT reading | SATR INPUT | 680 |
| SAT writing | SATW INPUT | 720 |
| GPA | GPA INPUT | 3.8 |
| Rank | RANK INPUT | 0.9 |
| Extra inputs | | |
| Curriculum | CURB INPUT | 5 |
| Honors | HONORS INPUT | 11 |
| Essays | ESSAYS INPUT | 4 |

In an exemplary embodiment, the calculations to achieve the predictor % for the selected college are shown in Table 4, Table 5 and Table 6 below. This provides what is the chance for a student to get admission in selected college

TABLE 4

| Calculated Variable | Equation | Result |
|---|---|---|
| SATM Mean | (SATM25 + SATM75)/2 | 655 |
| SATR_Mean | (SATR25 + SATR75)/2 | 645 |
| SATW Mean | (SATW25 + SATW75)/2 | 660 |
| SATM Dev | 1.4826022 * (SATM mean − SATM25) | 66.717 |
| SATR Dev | 1.4826022 * (SATR mean − SATR25) | 66.717 |
| SAT W Dev | 1.4826022 * (SATW mean − SATW25) | 59.304 |

TABLE 5

| | | | Weighted |
|---|---|---|---|
| | | | Percentage (PW) |
| | | | Weight from |
| | | Percentage | above weight |
| Scholastic | Equation | (P) | table |
| SAT math | NORM DIST(SATM_IN | 89.867 | 449.337 |
| SAT | NORM | 70.007 | 350.035 |
| Reading | | | |
| SAT | NORMDIST(SATW | 84.417 | 253.250 |
| Writing | INPUT, SATW mean, SATW | | |
| | dev, true) | | |
| GPA % | NORMDIST(GPA INPUT, | 84.134 | 336.538 |
| | GPA mean, GPA dev, true) | | |
| Rank % | NORMDIST(RANK | 50 | 150.000 |
| | INPUT, RANK mean, RANK | | |
| | dev, true) | | |
| Total | | | 1539.161 |

TABLE 6

| | | Percentage |
|---|---|---|
| Extra | Equation | (X) |
| Curriculum % | IF(CURR INPUT <CURRICULAM, | 2.000 |
| | −WCURRICULAM, +WCURRICULAM) | |
| Honors % | IF(HONORS INPUT <HONORS, | 3.000 |
| | −WHONORS, +WHONORS) | |
| Essays % | IF(ESSAYS INPUT <ESSAYS, | 3.000 |
| | −WESSAYS, +WESSAYS) | |
| Total | | 8.000 |

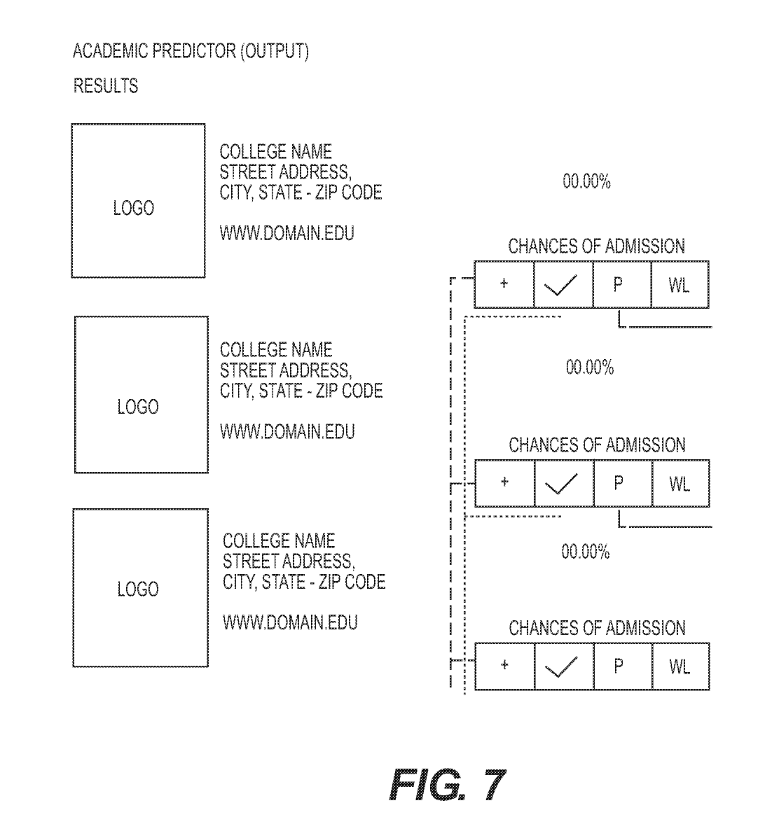

The final percentage provides an indicator of a student's chance for gaining admittance to a specific institution. The final calculation performed by the software is provided below. Also an illustration of the output results is illustrated in FIG. 7.

“WEIGHTED PERCENTAGE=(SUM(PW)/SUM(W)=1539.161/23.5=65.496% FINAL PREDICTOR OUTPUT FORA SCHOOL WEIGHTED PERCENTAGE+SUM(X)=65.496+8.000=73.496%”

Academic Suggestor

In another aspect of the application, users may select the Academic Suggestor to discover schools to apply to that fit their individual criteria for an ideal school. The Academic suggestor will present these schools to the user in three categories based on their difficulty of admission.

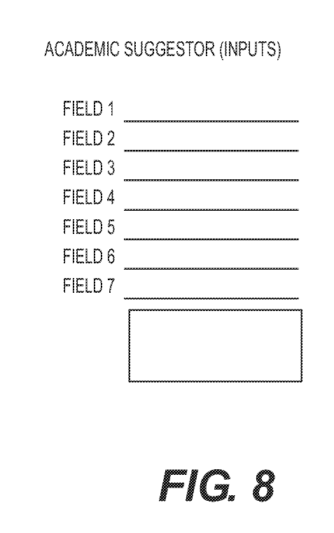

Users will be required to identify their school preferences to determine their criteria for an ideal school. Users will also be required to enter some personal and scholastic information. This information will be used to help determine the scope of schools which they should be applying to and to roughly determine their chance of admission (enough to place the schools into the categories). All of this information should be pulled from the user's profile if it exists there. Generally, the inputs are provided on a user interface as illustrated in FIG. 8.

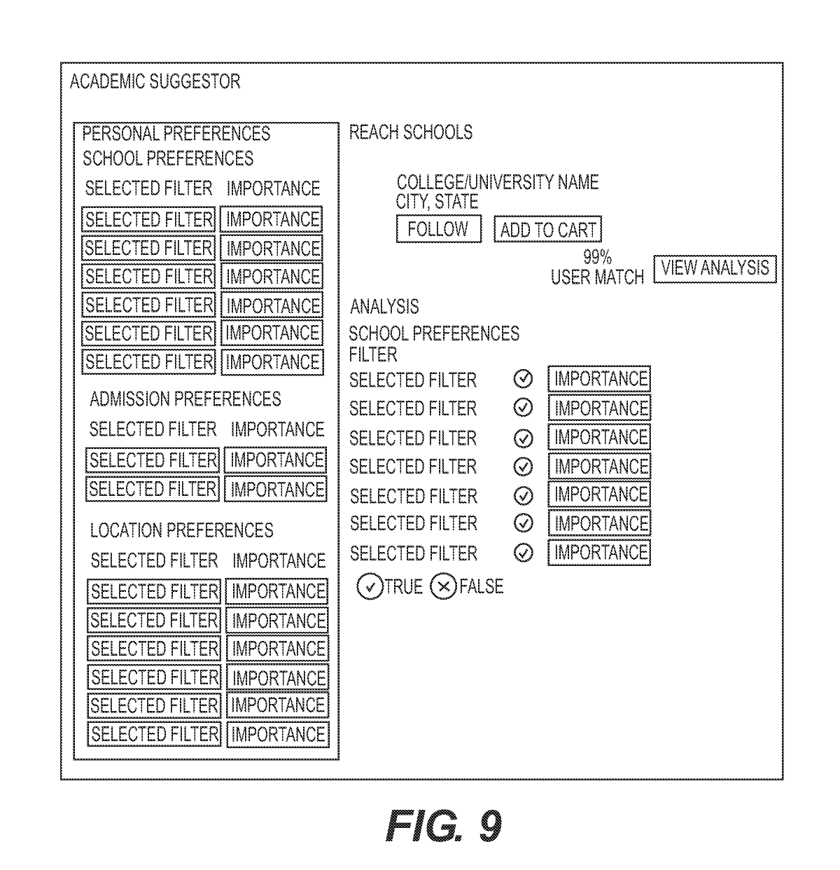

On the results page as illustrated in FIG. 9, the user will see the set number of schools for each category. These categories are ‘Reach Schools’, ‘Target Schools’, and ‘Safety Schools’. The schools are separated into these categories based on their chance of admission into each. ‘Reach Schools’ are the hardest schools to be admitted into, ‘Target Schools’ will have moderate probability, and ‘Safety Schools’ will have the most likely probability.

Meet the Dean

In yet another aspect of the application, there is described a product called ‘Meet the Dean’s a way of meeting with deans, faculty, and various other professionals associated with colleges. This allows students and parents to get important face time with these professionals who are typically too busy to meet with prospective students and their parents individually.

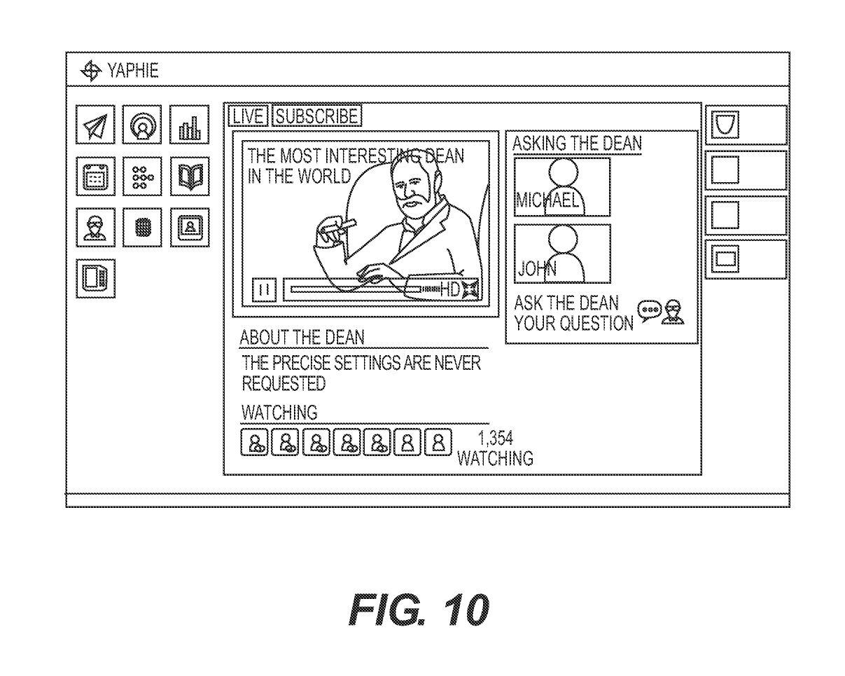

Users will be able to view streaming video or previously recorded video with deans, faculty, and other professionals from schools. During the video the dean will be prompted to ask selected questions from users’ submitted question. An exemplary embodiment of the interactive ‘Meet the Dean’ product is illustrated in FIG. 10.

Users will be able to submit questions to ask the guest as soon as the event is posted. Users will also be able to ask questions during the chat if it is being conducted live. After the event has concluded the video will still be viewable and the transcript of selected questions will be posted. Clicking ‘Follow’ adds the event to the user's ‘following list’ it also allows the user to receive notifications and alerts for this event in their user dashboard. Share allows the user to share the event profile page with Facebook or twitter

Student Communication

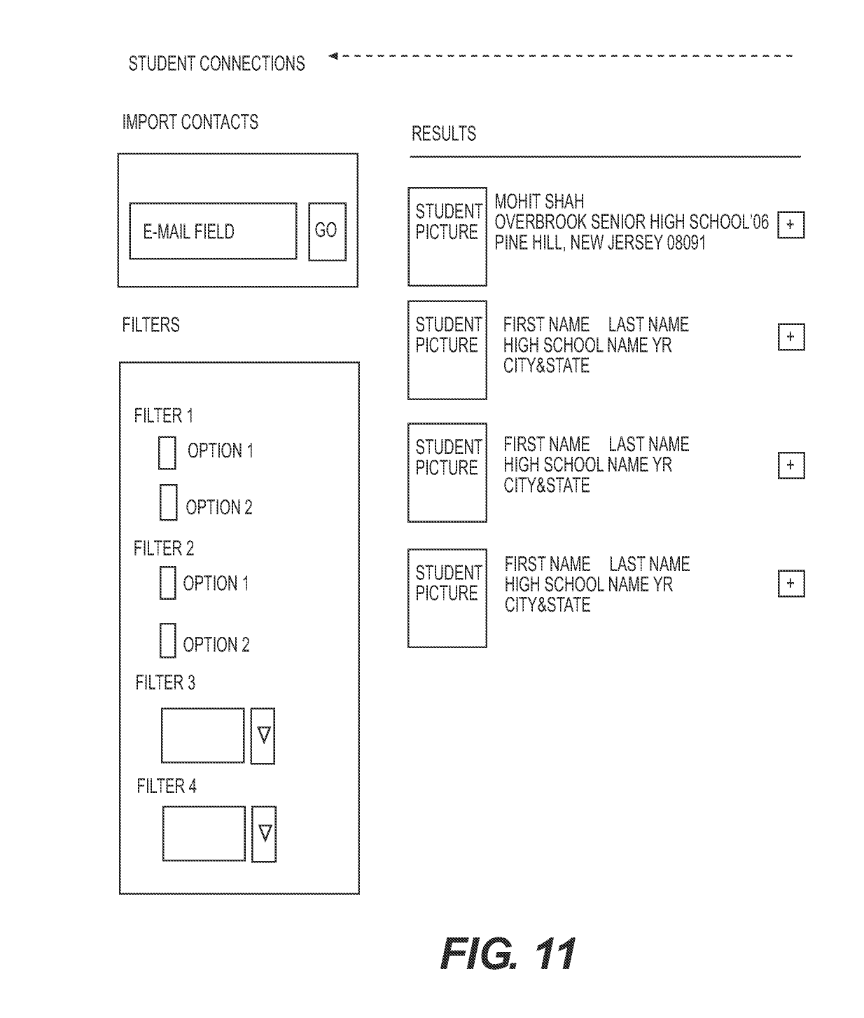

According to yet another aspect of the application, FIG. 11 illustrates a user interface for a Student Connection aspect. In this embodiment, the student has access to an email field, filters, and may upload a picture. This tool allows users to discover other users based on scholastic information, where they are applying, location, or based on interests. This allows users to gauge the demographics of their competition. Users can user this knowledge to differentiate themselves.

Users can search for other students based on scholastic information such as GPA, SAT scores, ACT Scores, Class rank, or GPA. The users will input a range of numbers when searching users by GPA, SAT (all scores), ACT (all scores), and class rank. Users will be able to search for other users that are following inputted schools. The user can either input a school by name, or by selecting it from the list of ‘following’ schools. Users can filter location by selecting a state from a drop down, or by inputting a zip code and setting a radius. Users can filter by Interested Majors. This searches for students that are interested in the inputted majors.

Competitive Analysis Tool

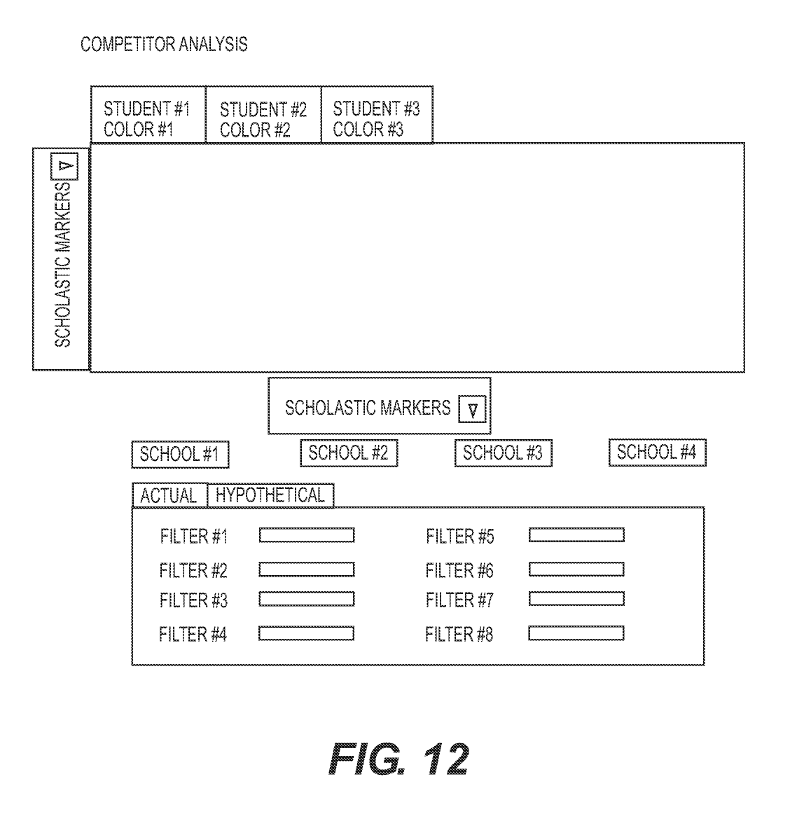

According to another aspect of the application, FIG. 12 illustrates a user interface for a competitor analysis aspect. With the student comparison tool users will be able to analyze their data as compared to other users and school expectations. The data used with this tool will all be pulled from student profiles and college profiles.

In an exemplary embodiment, the data selected to be displayed on each axis will be displayed as a scatterplot on this page. Users will add schools by inputting a school name or selecting one from the list of schools that they are currently ‘Following’. This will display the schools data in the scatter plot for the two shown variables. Users will add other users to display by typing in a user name, selecting a user from the ‘following’ list, or by having selected ‘compare to’ from another user's profile or results page. Users will be able to display all students ‘following’ selected schools. Users will be able to display all students with select schools added to their ‘carts’. Two different variables will be displayed, one on the X axis, and one on the Y axis. Users will be able to select the different variables to display on each axis. These variables generally will be limited to SAT scores, ACT scores, GPA, and Class Rank.

College Planning Blog/Forum

In yet a further aspect of the application, The college planning blog is provided on the platform via a user interface. The College planning aspect is configured to present to the user summaries of the college planning process and all of the tools available through the educational service system that the user can use during this planning process. This section may be configured to function similar to a standard ‘blog’.

Financial Planning

According to another aspect of the application, the financial planning section of the platform will allow the user to select one or more summaries of the financial planning process and all of the tools necessary for the user to utilize during the college planning process. In one embodiment, the financial planning section may be located under the college planning section of the platform. Under this section, descriptions or articles aimed at preparing the student for the financial planning process may be available. Clicking on an article should take you to that article's page which will display that content in greater detail. In another exemplary embodiment, the college planning section includes a blog section. In yet another embodiment, a link may direct the user to the product summary page for the user to assess whether to purchase any products/services.

Scholarship

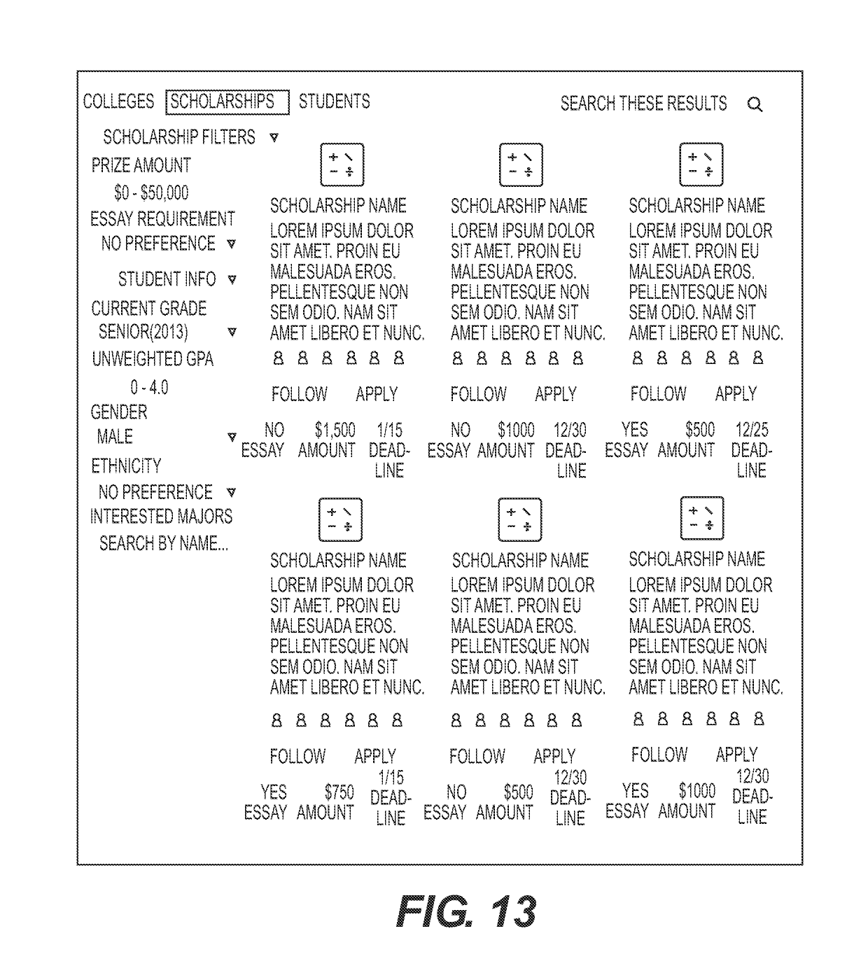

According to a further aspect of the application, FIG. 13 illustrates a user interface for an Advanced Scholarship Search aspect, and its relationship to other aspects of the system. Through this interface, users can search through available scholarships. The Advanced Scholarship Search aspect may be configured to obtain information. In an exemplary embodiment, the search aspect is configured such that the user may customize the search according to one or more search criteria including but not limited to prize amounts, essay requirements, GPA requires, gender requirement, ethnicity requirement, state of residence, college major requirement. The search aspect may also have a name search function that may include Boolean search string operators. The scholarship can require additional criteria, however, these requirements, one selected, generally are the criteria utilized by the platform to perform their search. If a field is left blank, the field will not appear on the profile page.

In the scholarship section, there is a link describing eligibility of each scholarship in the database. The eligibility allows users to further examine any scholarship within their populated search to assess whether they fulfill the requirements.

In another exemplary embodiment, there is a ‘Follow’ function. The follow function allows user to receive notifications and alerts for this scholarship in their user dashboard. In another embodiment, a ‘Share’ functions allows users to share the scholarship profile page with social media sites including but not limited to Facebook and Twitter.

In yet another embodiment, there is an ‘Apply’ function. The ‘Apply’ function allows users to send the scholarship application and its sources to email addresses.

In yet a further embodiment, a link may be provided to see which users are following the Scholarship profile. Users may have the option not to show other users their status of which Scholarships they have applied to. On the search results page the resulting scholarships will be, by default, sorted by relevance. Users can also sort by the displayed information. The fields that will be displayed on the scholarship search results page will be: Scholarship Name, Prize, number of winners, and deadlines all of which will be pulled from the scholarship's profile page.

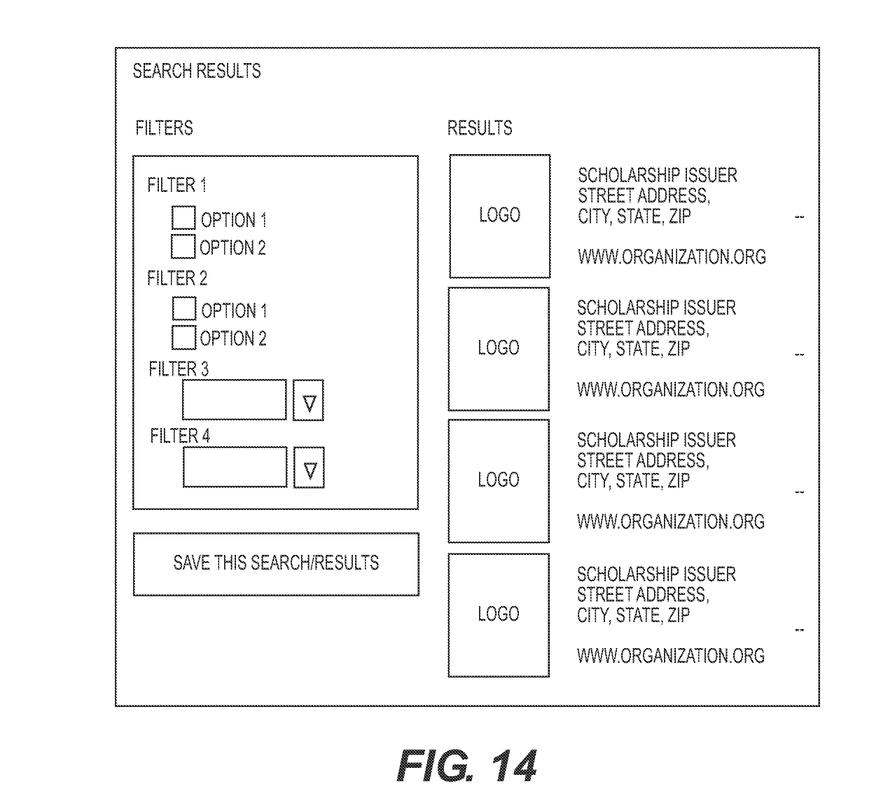

FIG. 14 illustrates a user interface display of the search results for a scholarship search. As shown, the results may be saved by the user for retrieval at a later date. In an exemplary embodiment, the searches may be customized such that they are automatically performed by the platform, for the user, according to a preset frequency. The results may be sent to the user on the platform and/or one or more email addresses desired by the user.

In another exemplary embodiment, the scholarship section may include a link to a brief summary of all of our products that directly relate to scholarship planning. This page will also link to all of said products' summary pages. Clicking on the article that is a product (see: Advanced Scholarship Search in the screenshot) will take you to that products summary page. In another embodiment, any Scholarship available on the platform will have a profile page. This page will display to the user various relevant information about the scholarship.

Loans and Financial Aid

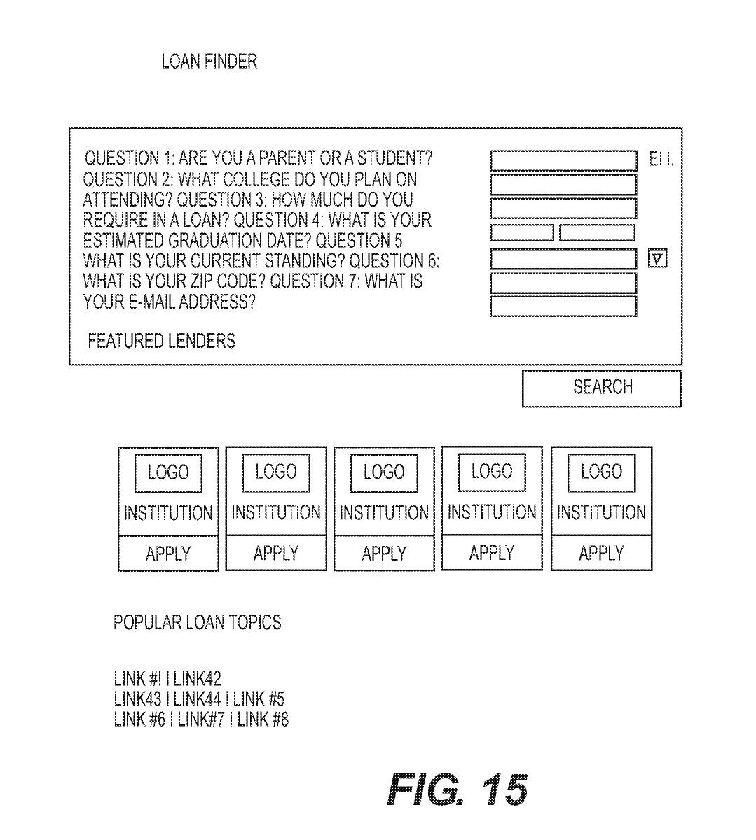

In another aspect of the application, the platform may include a loan finder as illustrated in FIG. 15. The platform has access to one or more lenders. Each lender with loans available will have a lender profile page. This page will display to the user various relevant information about all of the available loans they offer.

The loan availability section displays the data determining whether a student is able to apply for that loan based on the ‘college attending’ or ‘home zip’ inputs.

Loan Details display the lender variables used in displaying to the user his or her costs. ‘Following’ the lender allows the user to receive notifications and alerts for this lender in their user dashboard. Share allows the user to share the lender profile page through Facebook or twitter. Apply sends the user to the application page at its sources site.

The financial aid search tool may include one or more filters such as, for example, ‘College Attending’, Loan Amount, Graduation year, Current year (FR, SO, JR, SR), and home zip code. ‘College Attending’ and ‘Home Zip’ and ‘Loan Amount’ determine the lenders available. Each Lender profile will have a list of colleges they will loan to, zip's to loan to, and a range for the amount of money they will loan. ‘Graduation Year’ affects the APR Ranger for the loan available. For instance, a user graduating in 2013 will see different APR than a student graduating in 2014. Each lender's profile page will display the APR Range per graduation year. Users will be able to manipulate filters from this page. The filters should be set, by default, to no preference until the user selects a preference.

On the search results page, each result is configured to display two sets of ‘APR’ ‘Monthly Payments’, ‘Months’ ‘Total Cost’ for both the min and max value. ‘APR’ is displayed from the lenders profile based on the users inputted graduation year. ‘Monthly payments’ and ‘Total Cost’ are determined with interest calculations from the input ‘Loan Amount’ and the lender's APR. Apply sends the user to the application page at its sources site. These users should be able to save the results page from this page. Saving this will index this page in the user's dashboard under the saved items category.

Financial Aid

In another aspect of the application, the platform may have a link which accesses a search tool for financial aid. The financial aid tool includes but is not limited to loans, grants, and the FAFSA. Clicking on any of the forms populates a form fillable application. Much of the information in these forms may be populated with the user's information from the profile section. Many of the search queries and find features discussed in the scholarship and loan section also are applicable for the financial aid tool.

Tutoring Scheduling

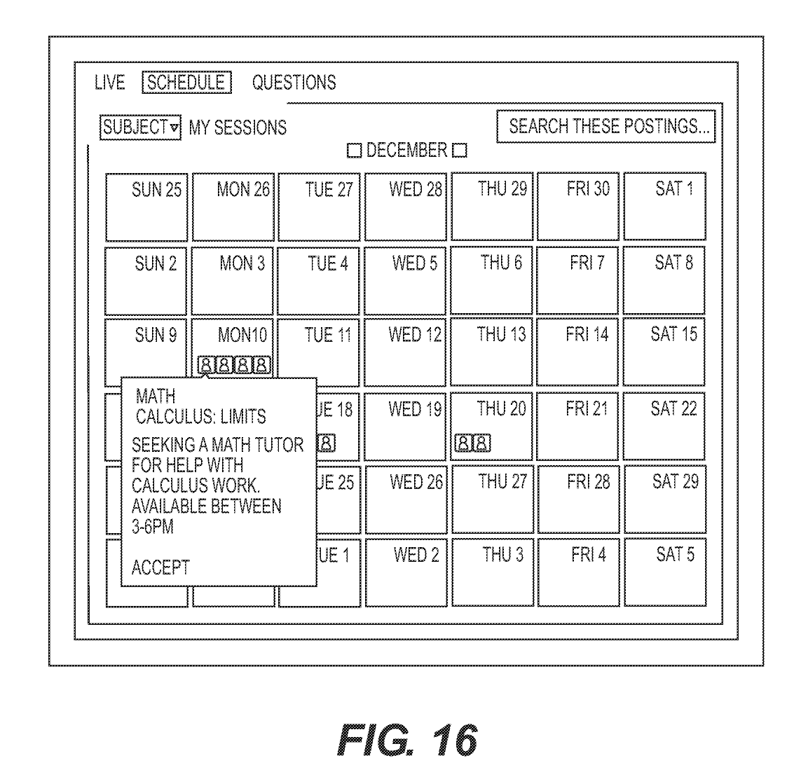

In another aspect of the application, there is a tutoring scheduling aspect of the platform. FIG. 16 illustrates a user display interfaces for the tutoring scheduling aspect including a calendar format. Other formats are available according to the user's configured display preferences including but not limited to weekly, daily, list views. The user display is accessible both by students and tutors. Specifically, computer instructions are run by a processor on a networked-computer, i.e., connected to the internet. The user display shows a calendar-based interface for accessing, by, for example, a web browser program executing on a student computer, features of the tutoring scheduling aspect.

Calendar-based interface may be configured to serve as a “landing page” from the platform as an initial interface provided to a student in response to a request to make use of the tutoring scheduling aspect. Calendar-based interface may be configured to, as illustrated, display student requests for tutoring. For example, as illustrated, if a tutoring request has been recorded for a student, for example by way of display interfaces provided for use of the tutoring scheduling aspect, the tutoring request may be graphically and/or textually displayed via calendar-based interface. In the illustrated calendar-based interface, tutoring requests are displayed as spanning across the days that have been recorded as available for a student.

FIG. 16 illustrates an example in which calendar-based interface provides features for providing details for a student tutoring request. In the illustrated interface the user may initiate a tutoring request by clicking a “Post for help” button. In response to this click, calendar-based interface provides, for example via a popup box, interface features allowing a student to, for example, identify a class subject, input a specific course for which help is sought, a description of the specific help sought, available dates, and available times. From information previously recorded with the platform, information such as courses in which the student is currently enrolled may be obtained in order to facilitate, for example, the identification of a course and/or subject. Calendar-based interface may also be configured to allow the student to modify or delete a recorded tutoring request. For example, such actions may be initiated by clicking on or otherwise selecting a tutoring request displayed in calendar-based interface. In one embodiment, a search function may be provided to aid in finding recorded tutoring requests.

In another exemplary embodiment, there is a calendar-based interface which indicates tutor availability in response to a tutoring request. For example, a visual notification indicating a number of tutors available for the particular request is provided indicating the availability of one or more tutors. Upon clicking on the event span, the student will see the notifications from the tutors who have accepted the event. The student may see the tutors' username and their ‘reputation’ (+125), and a message from the tutor. Once the student accepts a tutor he will be prompted to select a specific time and date for the tutoring event. After the student specifies a time and date, an event span will appear in that day of his calendar showing the time. This event span will become blue once the tutor confirms this event, in some embodiments, indications of tutor availability and tutor confirmation may be provided through other interfaces, such as an event notification interface provided by the educational platform for common use by its various aspects.

In another exemplary embodiment, there is a platform whereby a tutor may response a one or more student tutoring requests. The schedule will be the landing page for tutor users navigating to this module. On the schedule page the tutor will be able to see all events created by users. The tutor will see the students' thumbnails for each day he or she has selected as available. The tutor can filter these results by subject or by searching. The tutor can also page through the months of the calendar. The tutor can see all of his or her scheduled events by clicking ‘My sessions’. Notifications will appear in this span within the blue box.

In a further exemplary embodiment, the tutor is permitted, via the platform, to submit a response to an individual tutoring request. Upon hovering over a student's thumbnail, the tutor will see the details for that student's event. By clicking accept the tutor will notify the student that he or she is willing and capable to tutor the student on the day selected. Upon clicking accept, the tutor will specify a time, and can also include a message that the student will see when accepting or rejecting the tutor.

In yet a further exemplary embodiment, the platform is configured so as to allow a tutor to review pending and accepted tutoring requests. Once an event is applied for by the tutor, it will appear within the tutor's ‘My session’ page. Once the tutor has been accepted by the student that event's span will appear in blue. Events pending acceptance will appear in grey. Completed events will appear on the tutor's calendar in green. The tutor can choose to cancel an event if he or she is no longer able or willing to participate.

Question and Answer Board

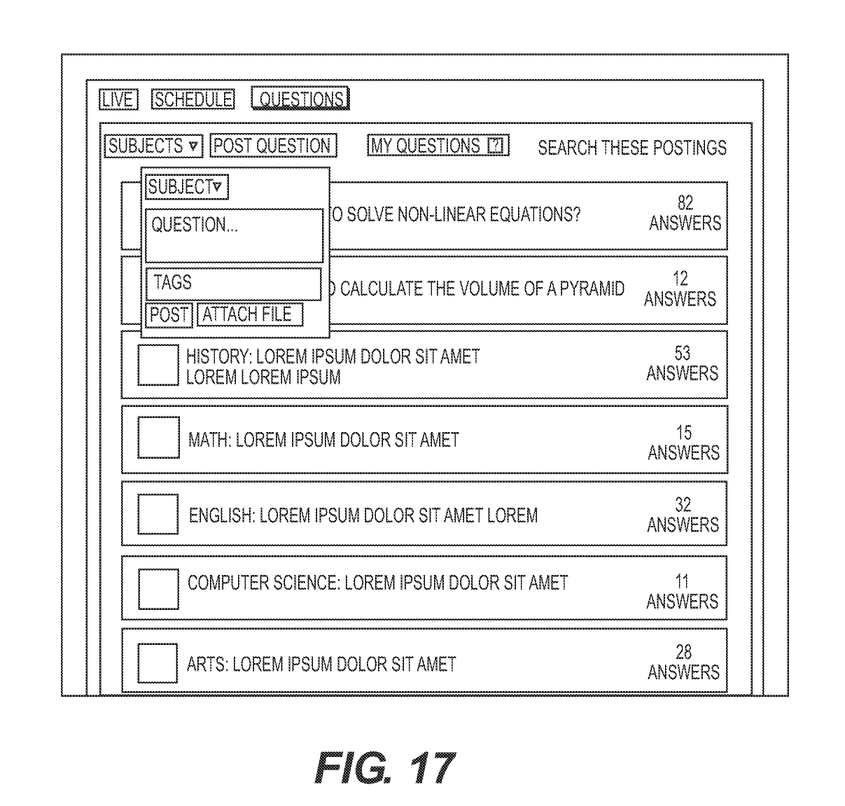

In another aspect of the application, the educational platform may comprise a question board aspect. FIG. 17 illustrates a question and answer platform accessible by both students and tutors. Many of the functions in question and answer board are found in question/answer websites such as, for example, stackoverflow.com, quora.com, and Yahoo answers. As shown in FIG. 17, categories such as subject, post questions and my questions are provided. On the right hand side of the question board, the number of posts is shown to the user. Through a question board interface, a student can browse any questions that other students have posted. Question board interface may be configured to allow browsing of questions by paging through results, a search interface, and/or filtering questions by subject. Also, question board interface is configured to allow the student to post questions of his or her own. In the illustrated example, upon clicking the “My Questions” interface element, the student will be shown only the questions he or she has posted, allowing the student to quickly review the status of his or her outstanding questions.

In an exemplary embodiment, a student may post a new question. Upon clicking ‘Post Question’ the user will be able to create a question by choosing a subject, writing his/her question, and describing tags. In the illustrated embodiment, the student can also elect to attach a file, which will be uploaded to the question board aspect, and made available to other users through the question board aspect. Additionally, as illustrated, in the event that answers are received in response to the student's questions, question board interface maybe configured to display a notification in the “My Questions” interface element. In the illustrated example, the notification includes an indication of the number of replies presented in a blue box in the “My Questions” button.

In an exemplary embodiment, a question thread interface is provided allowing the student to review a question and any received responses. In one embodiment, the educational platform may be configured such that, for example, upon selecting a question displayed on question board interface the user will be navigated to a question thread interface corresponding to the selected question. Question thread interface may be configured to award individual responses with an up (i.e., positive) or down (i.e., negative) scoring. Question thread interface may be configured such that aggregate scoring among users of the question board aspect affects the position of the response. Question thread interface may be configured such that if a response is given a particular number of downs the response will be hidden, which may include not providing any indication of the response, or requiring additional user action in order to make the negatively ranked response visible. In an embodiment, if the student is viewing his or her own question then he or she will be able to select a response as the solution. If a response is selected as the solution, a green box with a check mark will appear. Students can reply to a response by clicking the reply interface element. In an embodiment, this will indent the reply under the replied response.

In a further exemplary embodiment of the question and answer board, a tutor question board interface is provided. From this page, the tutor will be able to browse any questions that students have posted by paging through results, searching, or filtering questions by subject. Tutors will not be able to post questions. Upon clicking in ‘my answers’, the tutor will be able to see all of the questions he or she has posted answers to.

In yet a further exemplary embodiment, there is a tutor question thread interface allowing the tutor to review a question, review any received responses, and submit a response.

Virtual Tutoring Session

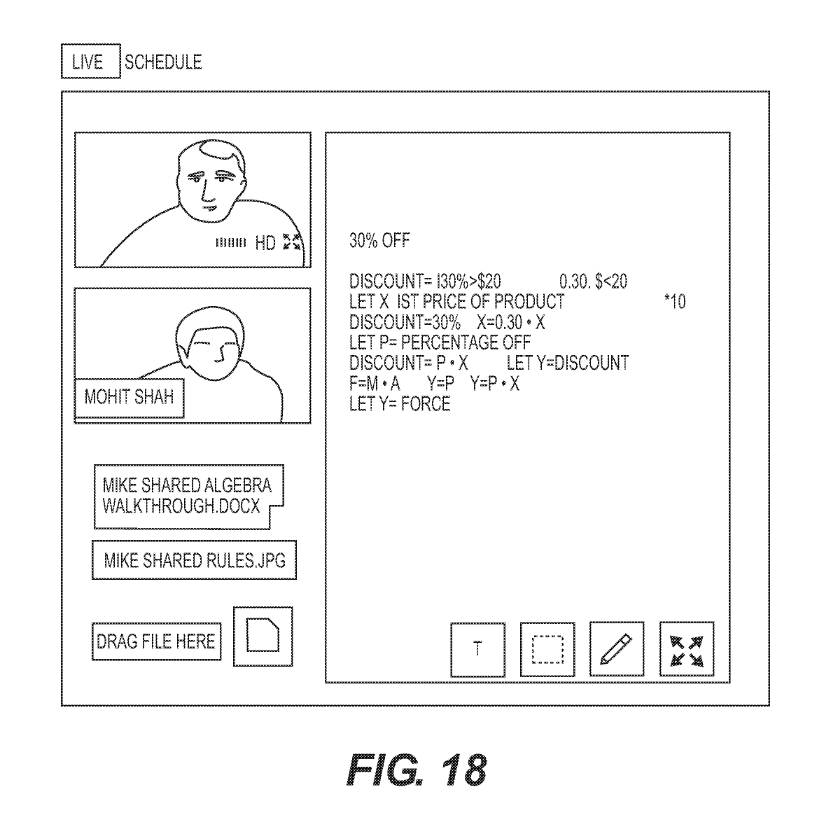

In accordance with another aspect of the application, the Educational platform may comprise a live workspace. FIG. 18 illustrates examples of display interfaces for the live workspace aspect, in use between a student and tutor. The student will be able to share their camera and/or their microphone with the tutor. The student will also be able to upload documents by clicking on the add document icon, or by dragging a document into the document space. The workspace, displayed to the right of the video interface component is editable by both the tutor and the student. In an exemplary embodiment, the icons in the bottom right of the workspace will allow the user to access different tools to use within the workspace such as text, shapes, pens, and worksheet functionality. The student should also be able to full screen the workspace.

In an exemplary embodiment, once the student navigates to the live workspace page he or she will be prompted to choose between joining his/her next scheduled event or ‘play in workspace’. Choosing ‘Join this event’ will put the user into the workspace that the tutor and the student will share. Once the tutor joins the shared workspace the tutoring event can begin.

In another embodiment, choosing ‘Play in workspace’ will put the user into an unshared workspace. That is, the information will not be shared with the tutor before, during or after the tutoring session.

Event Presentation

In another aspect of the invention, the educational platform may comprise an event presentation aspect. The event presentation aspect may be employed, in somewhat similar fashion as the Meet the Dean's product illustrated in FIG. 10, whereby students may attend a live web-event, employing audio and video capabilities. By employing the audio and video software, students attend an interactive session.

Hardware

The hardware elements, operating systems and programming languages of such computers are conventional in nature, and it is presumed that those skilled in the art are adequately familiar therewith. Of course, the server functions may be implemented in a distributed fashion on a number of similar platforms, to distribute the processing load.

Hence, aspects of the disclosed techniques can be executed on a network element such as a server. Program aspects of the disclosed techniques may be thought of as “products” or “articles of manufacture” typically in the form of executable code and/or associated data that is carried on or embodied in a type of machine readable medium. “Storage” type media include any or all of the memory of the mobile stations, computers, processors or the like, or associated modules thereof, such as various semiconductor memories, tape drives, disk drives and the like, which may provide storage at any time for the software programming. All or portions of the software may at times be communicated through the Internet or various other telecommunication networks, Such communications, for example, may enable loading of the software from one computer or processor into another computer or processor. For example, software and/or instructions may be communicated from a server to a client. Similarly, software for a server may be loaded into the hardware platform or platforms selected to perform that server function. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the data aggregator, the customer communication system, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the system and method have been described in terms of what are presently considered to be specific aspects, the disclosure need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

1. A method for assisting a student in the enrollment and admission process for post-secondary education, the method comprising the steps of:
collecting user data from said student;
collecting admission data from one or more post-secondary institutions;
analyzing said user data in view of said admission data; and
delivering at least one of the following recommendations to said student: (i) required courses to complete prior to enrolling at said one or more post-secondary institutions; (ii) probability of gaining admittance to said one or more post-secondary institutions; and (iii) suggestion for applying to said one or more post-secondary institutions according to said user data.

2. The method according to claim 1, wherein at least two of said recommendations are delivered to said student.

3. The method according to claim 2, wherein each of said recommendations is delivered to said student.

4. The method according to claim 1, further comprising:
determining said student has selected said one or more post-secondary institutions for said step of analyzing.

5. The method according to claim 1, further comprising:
generating a comparative analysis upon determining a request to compare said user data with additional user data of one or more other students in view of said admission data.

6. The method according to claim 5, further comprising:
delivering said comparative analysis to said student.

7. The method according to claim 1, further comprising:
providing an audio and visual interface configured such that said student may communicate with a representative of said one or more post-secondary institutions.

8. The method according to claim 1, further comprising:
providing a tutor scheduling interface configured such that said student and a tutor may communicate to schedule a date and time for tutoring assistance.

9. The method according to claim 1, further comprising:
providing a question board interface configured such that said student may post questions and/or search posted question threads.

10. The method according to claim 1, further comprising:
providing a live workspace interface with audio and visual capability configured so that said student and a tutor may conduct a tutoring session.

11. A system for assisting a student in the admission process for post-secondary education, the system comprising:
a database including user data collected from said student, and admission data collected from one or more post-secondary institutions;
a platform, operating on a networked computer, configured to analyze said user data in view of said admission data, said platform including at least one of the following student recommendation tools: (i) an academic tracker configured to identify remaining courses said student should complete prior to enrolling at said one or more post-secondary institutions; (ii) an academic predictor configured to provide said student with the probability of gaining admittance to said one or more post-secondary institutions; and (iii) an academic suggestor configured to provide said student with suggestions for applying to said one or more post-secondary institutions based upon said user data.

12. The system according to claim 11, wherein said platform includes at least two of said student recommendation tools.

13. The system according to claim 12, wherein said platform includes each of said student recommendation tools.

14. The system according to claim 11, wherein said platform is configured to determine when said student has selected at least one of said one or more post-secondary institutions for analysis.

15. The system according to claim 11, wherein said platform further includes a comparative analysis tool configured to generate a comparative analysis upon determining a request to compare said user data with additional user data of one or more other students in view of said admission data.

16. The system according to claim 11, wherein said platform further includes an audio and visual interface configured so that said student may communicate with a representative of said one or more post-secondary institutions.

17. The system according to claim 11, wherein said platform further includes a tutor scheduling interface configured so that said student and a tutor may communicate with each other to schedule a date and time for tutoring assistance.

18. The system according to claim 11, wherein said platform further includes a question board interface configured so that said student may post questions and/or search posted question threads.

19. The system according to claim 11, wherein said platform further includes a live workspace interface including audio and visual capability configured so that said student and a tutor may conduct a tutoring session.

20. The system according to claim 11, wherein said platform further includes a scholarship recommendation tool configured to recommend scholarships to said student based upon said user data.
